(19) United States
(12) Patent Application Publication
(10) Pub. No.: US 2024/0419029 A1
(43) Pub. Date: Dec. 19, 2024

(54) ELECTRONIC DEVICE

(71) Applicant: InnoLux Corporation, Miao-Li County (TW)

(72) Inventors: Ming-Che HUANG, Miao-Li County (TW); Rong-Jyun LIN, Miao-Li County (TW); I-Wen YANG, Miao-Li County (TW); Chien-Chih LIU, Miao-Li County (TW); Ching-Shan LIN, Miao-Li County (TW); Chi-Chau LIN, Miao-Li County (TW)

(21) Appl. No.: 18/664,631

(22) Filed: May 15, 2024

(30) Foreign Application Priority Data
Jun. 15, 2023 (CN) 202310709790.X

(51) Int. Cl. G02F 1/1335; G02F 1/1333

(52) U.S. Cl. CPC G02F 1/133504; G02F 1/133382; G02F 1/133502; G02F 1/133512; G02F 1/133528

(57) ABSTRACT

An electronic device includes a light scattering switching element, a light absorbing switching element and a thermal insulation layer. The light absorbing switching element is disposed opposite to the light scattering switching element. The thermal insulation layer is disposed between the light scattering switching element and the light absorbing switching element, wherein the thermal conductivity of the thermal insulation layer is less than 50×10⁻³ W·m⁻¹·K⁻¹.

### CROSS-REFERENCE TO RELATED APPLICATIONS

This application claims the benefits of the Chinese Patent Application Serial Number 202310709790.X, filed on Jun. 15, 2023, the subject matter of which is incorporated herein by reference.

### BACKGROUND

### Field of the Disclosure

The present disclosure relates to an electronic device and, more particularly, to an electronic device that can be applied to outdoor smart windows and has both display and projection functions.

### Description of Related Art

Currently, smart windows may be absorbing type dimming windows or scattering type dimming windows. In consideration of smart windows requiring the thermal insulation and projection functions, there is a need to provide an improved electronic device to satisfy the above requirements.

### SUMMARY

The present disclosure provides an electronic device, which includes: a light scattering switching element; a light absorbing switching element disposed opposite to the light scattering switching element; and a thermal insulation layer disposed between the light scattering switching element and the light absorbing switching element, wherein the thermal insulation layer has a thermal conductivity less than 50×10⁻³ W·m⁻¹·K⁻¹.

Other novel features of the disclosure will become more apparent from the following detailed description when taken in conjunction with the accompanying drawings.

### BRIEF DESCRIPTION OF DRAWINGS

FIG. 1A is a three-dimensional schematic diagram of an electronic device according to an embodiment of the present disclosure;

FIG. 1B is a cross-sectional view of the electronic device taken along line L-L′ of FIG. 1A;

FIG. 2A shows the assembly process and the assembled structure of the light scattering switching element of the electronic device according to the present disclosure;

FIG. 2B shows the assembly process and the assembled structure of the light absorbing switching element of the electronic device according to the present disclosure.

FIG. 3A schematically illustrates the structure and operation of the light absorbing panel of the electronic device according to the present disclosure;

FIG. 3B schematically illustrates the structure and operation of the light scattering panel of the electronic device according to the present disclosure;

FIG. 4 schematically illustrates the process of assembling the light scattering switching element and the light absorbing switching element of the electronic device into a thermal insulation glass window according to the present disclosure;

FIG. 5 schematically illustrates the process of introducing inert gas between the light scattering switching element, the light absorbing switching element and the frame member of the electronic device according to the present disclosure;

FIG. 6 is a schematic diagram of an electronic device according to another embodiment of the present disclosure; and

FIG. 7 is a schematic diagram of an electronic device according to still another embodiment of the present disclosure.

### DETAILED DESCRIPTION OF EMBODIMENT

The following disclosure provides many different embodiments or examples for implementing different components in the provided electronic device. Specific examples of each component and its configuration are described below to simplify the embodiments of the present disclosure. However, these are only examples and are not intended to limit the present disclosure. For example, if the description mentions that a first component is formed on a second component, it may include an embodiment in which the first and second components are in direct contact, or may include an additional component formed between the first and second components, so that they are not in direct contact. In addition, embodiments of the present disclosure may repeatedly use component symbols and/or characters in different examples. This repetition is for the sake of brevity and clarity and is not intended to indicate the relationship between the different embodiments and/or forms in discussion.

Directional terms mentioned in the specification, such as “up”, “down”, “front”, “rear”, “left”, “right”, etc., only refer to the directions of the drawings. Accordingly, the directional term used is illustrative, not limiting, of the present disclosure.

In some embodiments of the present disclosure, terms related to joint and connection, such as “connect”, “interconnect” and similar terms, unless otherwise defined, may refer to two structures in direct contact, or may also refer to two structures not in direct contact in which there are other structures disposed between the two structures. The terms related to joint and connection may also include the situation where both structures are movable or both structures are stationary. In addition, the terms “electrical connection” and “coupling” include any direct and indirect electrical connecting means.

In the specification and claims, unless otherwise specified, ordinal numbers, such as “first” and “second”, used herein are intended to distinguish elements rather than disclose explicitly or implicitly that names of the elements bear the wording of the ordinal numbers. The ordinal numbers do not imply what order an element and another element are in terms of space, time or steps of a manufacturing method. Thus, what is referred to as a “first element” in the specification may be referred to as a “second element” in the claims. The terms, such as “about”, “substantially”, or “approximately”, are generally interpreted as within 10% of a given value or range, or as within 5%, 3%, 2%, 1%, or 0.5% of a given value or range.

Furthermore, any two values or directions used for comparison may have certain errors. If the first value is equal to the second value, it implies that there may be an error of about 10% between the first value and the second value. If the first direction is perpendicular or “substantially” perpendicular to the second direction, the angle between the first direction and the second direction may be between 80 degrees and 100 degrees. If the first direction is parallel or “substantially” parallel to the second direction, the angle between the first direction and the second direction may be between 0 degrees and 10 degrees.

Unless otherwise defined, all terms (including technical and scientific terms) used herein have the same meaning as commonly understood by those skilled in the art related to the present disclosure. It can be understood that these terms, such as those defined in commonly used dictionaries, should be interpreted as having meaning consistent with the relevant technology and the background or context of the present disclosure, and should not be interpreted in an idealized or excessively formal way. Unless there is a special definition in the embodiment of the present disclosure.

Some variations of the embodiments are described below. Similar reference numbers are used to identify similar components in the various drawings and illustrated embodiments. It is appreciated that additional operations may be provided before, during, and after the method, and some of the described operations may be replaced or deleted for other embodiments of the method.

It should be understood that, according to the embodiments of the present disclosure, an optical microscope (OM), a scanning electron microscope (SEM), a film thickness profiler (α-step), an ellipse thickness gauge or other suitable measurement means may be used to measure the depth, thickness, width or height of each component, or the spacing or distance between components. According to some embodiments, a scanning electron microscope may be used to obtain a cross-sectional structural image including the components to be measured, and measure the depth, thickness, width or height of each component, or the spacing or distance between components.

In addition, the shape of the electronic device may be a rectangular shape, a circular shape, a polygonal shape, a shape with curved edges, or other suitable shapes. The electronic device may have peripheral systems such as a driving system, a control system, a light source system, a shelf system, etc. so as to support the display device, antenna device or tiled device.

It is noted that the electronic device may be any combination of the above, but not limited thereto. It is further noted that the following embodiments may be replaced, reorganized, and mixed to complete other embodiments without departing from the spirit of the present disclosure. As long as the features of the various embodiments do not violate the spirit of the invention or conflict with each other, they can be mixed and matched arbitrarily.

Unless otherwise defined, all terms (including technical and scientific terms) used herein have the same meaning as commonly understood by those skilled in the art related to the present disclosure. It can be understood that these terms, such as those defined in commonly used dictionaries, should be interpreted as having meaning consistent with the relevant technology and the background or context of the present disclosure, and should not be interpreted in an idealized or excessively formal way. Unless there is a special definition in the embodiment of the present disclosure.

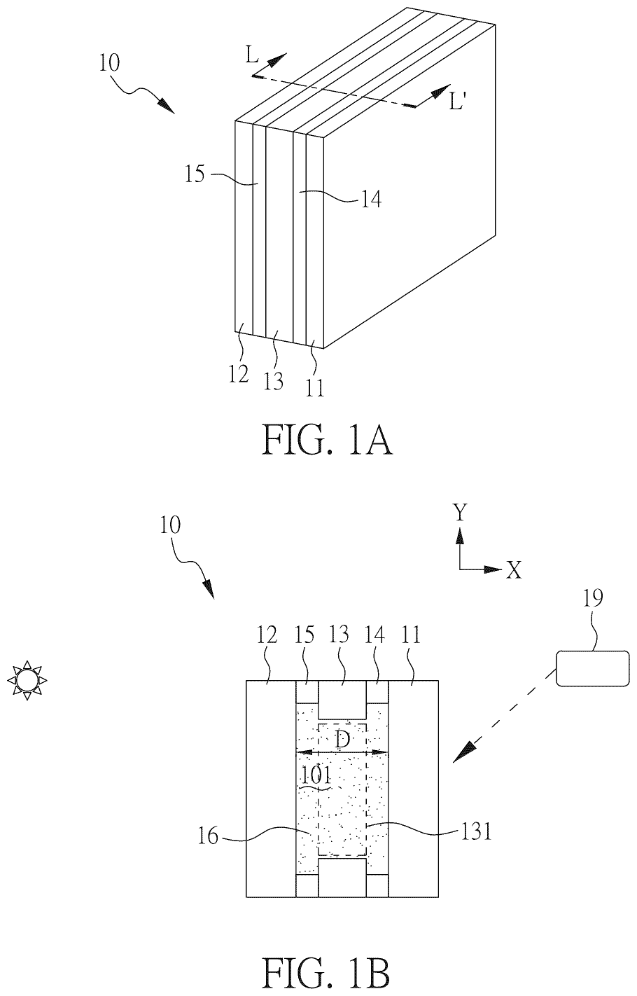

With reference to FIG. 1A and FIG. 1B, FIG. 1A is a three-dimensional schematic diagram of an electronic device 10 according to an embodiment of the present disclosure, and FIG. 1B is a cross-sectional view of the electronic device 10 taken along line L-L′ of FIG. 1A. As shown, the electronic device 10 includes a light scattering switching element 11, a light absorbing switching element 12, a frame member 13, a first attachment member 14, a second attachment member 15 and a thermal insulation layer 16, wherein the light scattering switching element 11 and the light absorbing switching element 12 are arranged along one direction (X direction), and the light absorbing switching element 12 is disposed opposite to the light scattering switching element 11. The thermal insulation layer 16 is arranged between the light scattering switching element 11 and the light absorbing switching element 12, and the thermal conductivity of the thermal insulation layer 16 is less than 50×10⁻³ W·m⁻¹·K⁻¹, but it is not limited thereto. In some embodiments, the thermal conductivity of the thermal insulation layer 16 is less than 40×10⁻³ W·m⁻¹·K⁻¹ or 35×10⁻³ W·m⁻¹·K⁻¹, but it is not limited thereto. In some embodiments, the thermal conductivity of the thermal insulation layer 16 is greater than or equal to 1 W·m⁻¹·K⁻¹ and less than 40×10⁻³ W·m⁻¹·K⁻¹, but it is not limited thereto. In this embodiment, the electronic device 10 is exemplified by a heat-insulating window for illustration, but it is not limited thereto, while the electronic device 10 may be subject to other product applications. The light absorbing switching element 12 of the electronic device 10 is, for example, disposed on the outdoor side of the heat-insulating window, and the light scattering switching element 11 is, for example, disposed on the indoor side of the heat-insulating window. A projector 19 may be disposed indoors, and the projector 19 may, for example, project images on the heat-insulating window, but it is not limited thereto.

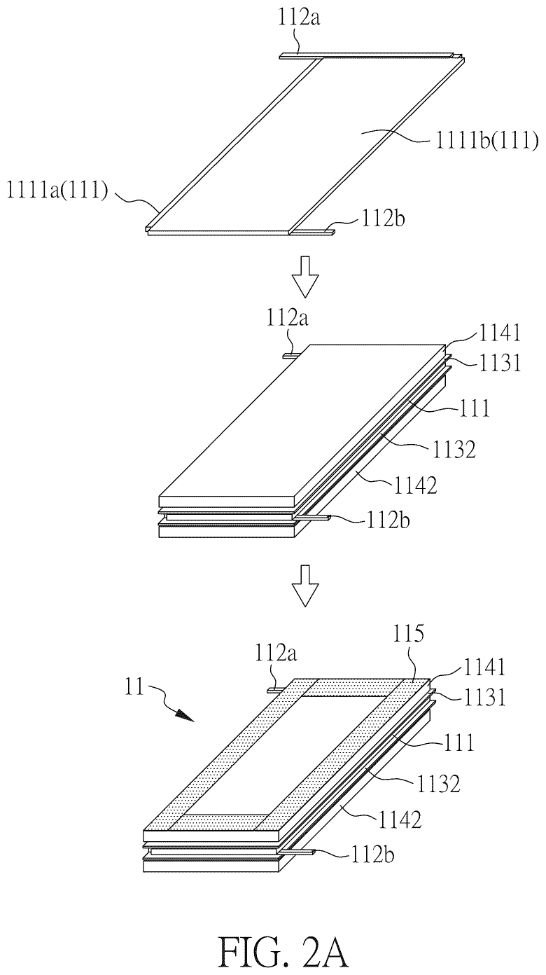

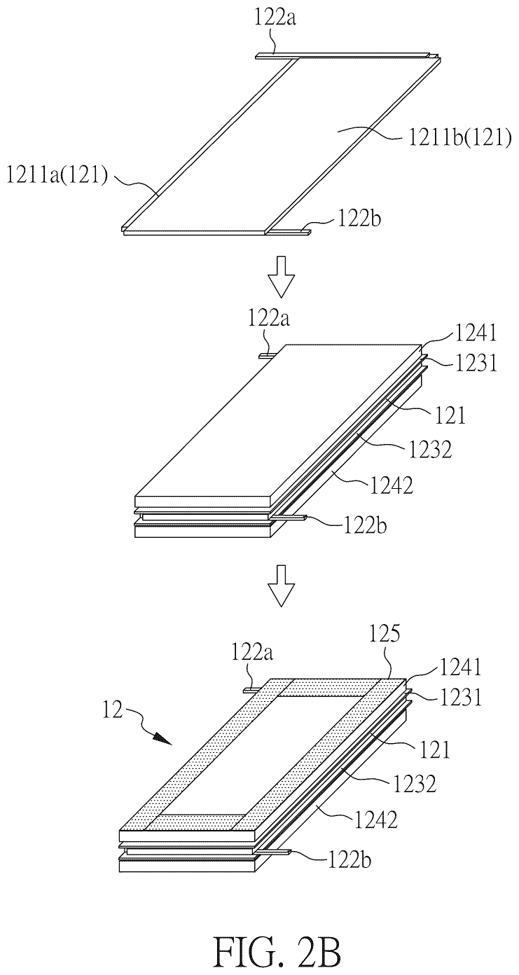

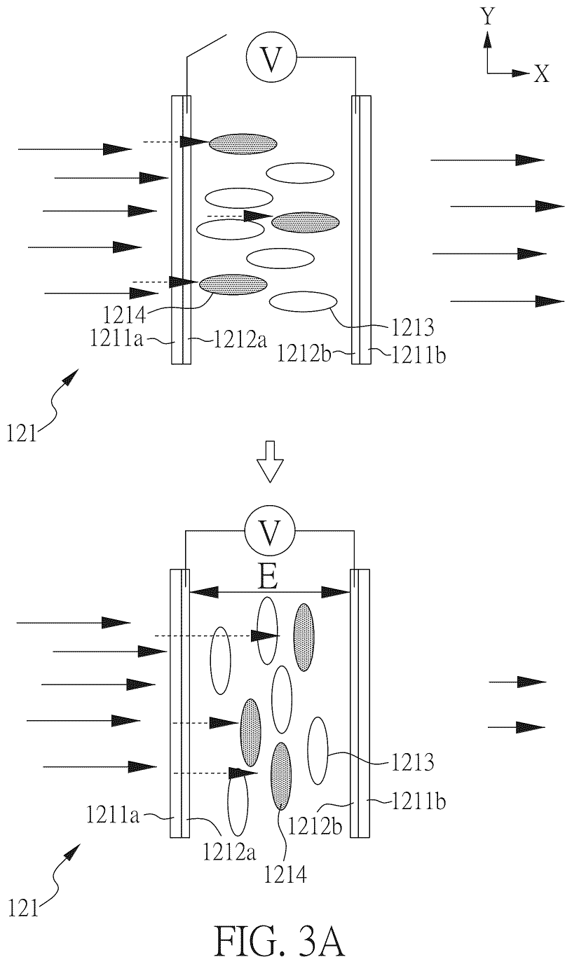

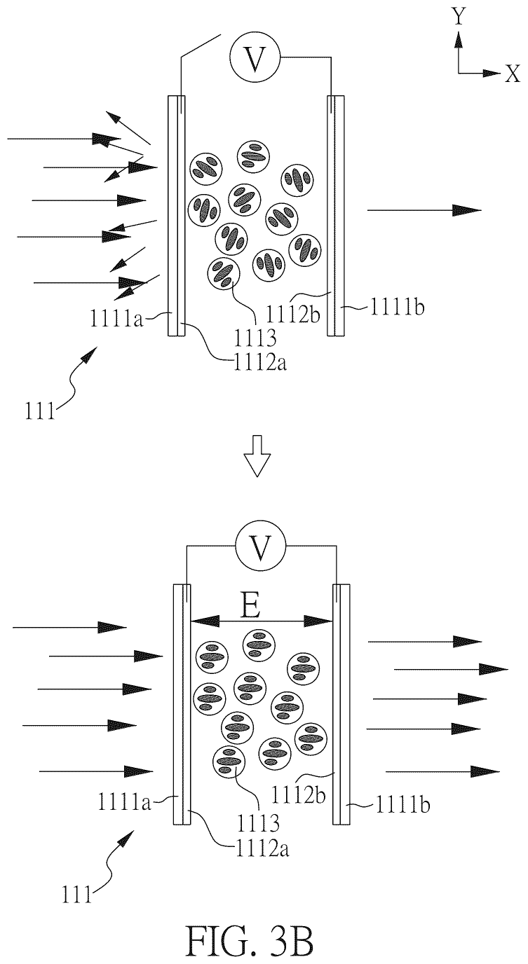

FIG. 2A schematically illustrates the assembly process and the assembled structure of the light scattering switching element 11. In the assembly of the light scattering switching element 11, a light scattering panel 111 is first provided. The light scattering panel 111 is formed by assembling, for example, a substrate 1111a and a substrate 1111b, and providing a light scattering material 1113 between the substrate 1111a and the substrate 1111b (for example, light scattering liquid crystal, please refer to the subsequent description of FIG. 3B). The thickness of the substrate 1111a or the substrate 1111b may be between 1 mm and 0.2 mm, but it is not limited thereto. There are conductive wires 112a and 112b (such as thin metal wires, but it is not limited thereto) are respectively provided on the peripheries, such as peripheral circuit areas (not labeled), of the substrate 1111a and the substrate 1111b of the light scattering panel 111. The conductive wires 112a and 112b are respectively used to receive, for example, the signals provided by an external circuit (not shown) to drive the light scattering panel 111 for dimming, wherein the signals received by the conductive wires 112a and 112b are different, for example. In FIG. 2A, the peripheral circuit areas (not labeled) of the substrate 1111a and the substrate 1111b are, for example, disposed on opposite sides, but it is not limited thereto. Next, the first substrate 1141 is attached to one side of the light scattering panel 111 through the first attachment layer 1131, and the second substrate 1142 is attached to the other side of the light scattering panel 111 through a second attachment layer 1132. The first attachment layer 1131 and the second attachment layer 1132 may include ethylene-vinyl acetate copolymer (EVA) or other suitable attachment layers, and the first substrate 1141 and/or the second substrate 1142 may be exemplified by hard substrates with a thickness of approximately between 2 mm and 10 mm (2 mm≤thickness≤10 mm), but it is not limited thereto. The first substrate 1141 and/or the second substrate 1142 may be, for example, architectural glass, but it is not limited thereto. By attaching the light scattering panel 111 between the first substrate 1141 and the second substrate 1142, the overall rigidity may be improved. Accordingly, the light scattering switching element 11 includes the first substrate 1141, the first attachment layer 1131, the light scattering panel 111, the second attachment layer 1132 and the second substrate 1142 that are stacked in sequence. Furthermore, a first decorative layer 115 may be optionally provided on the surface of the light scattering switching element 11 away from the frame member 13. For example, the first decorative layer 115 may be provided on the side of the first substrate 1141 opposite to the light scattering panel 111, so as to cover the conductive wire 112 to achieve aesthetic effect, but it is not limited thereto. The first decorative layer 115 includes, for example, light-shielding materials, such as ink, black photoresist, absorbing glue, other suitable materials, or a combination thereof.

FIG. 2B schematically illustrates the assembly process and the assembled structure of the light absorbing switching element 12. In the assembly of the light absorbing switching element 12, a light absorbing panel 121 is first provided. The light absorbing panel 121 is formed by assembling, for example, a substrate 1211a and a substrate 1211b, and providing liquid crystal molecules 1213 and dye molecules 1214 between the substrate 1211a and the substrate 1211b (please refer to the subsequent description of FIG. 3A). The thickness of the substrate 1211a or the substrate 1211b may be between 1 mm and 0.2 mm, but it is not limited thereto. Similar to the light scattering switching element 11, there are conductive wires 122a and 122b (such as thin metal wires, but it is not limited thereto) are respectively provided on the peripheries, such as peripheral circuit areas (not labeled), of the substrate 1211a and the substrate 1211b of the light absorbing panel 121. The conductive wires 122a and 122b are respectively used to receive, for example, signals provided by an external circuit (not shown) to drive the light absorbing panel 121 for dimming, wherein the signals received by the conductive wires 122a and 122b are different, for example. In FIG. 2B, the peripheral circuit areas (not labeled) of the substrates 1211a and 1211b are, for example, disposed on opposite sides, but it is not limited thereto. Next, the third substrate 1241 is attached to one side of the light absorbing panel 121 through the third attachment layer 1231, and the fourth substrate 1242 is attached to the other side of the light absorbing panel 121 through the fourth attachment layer 123. The third attachment layer 1231 and the fourth attachment layer 1232 include polyvinyl butyral (PVB) or other suitable attachment layers, and the third substrate 1241 and the fourth substrate 1242 may be exemplified by hard substrates with a thickness of approximately between 2 mm and 10 mm (2 mm≤thickness≤10 mm), but it is not limited thereto. The third substrate 1241 and/or the fourth substrate 1242 may be, for example, architectural glass, but it is not limited thereto. By attaching the light absorbing panel 121 between the third substrate 1241 and the fourth substrate 1242, the overall rigidity may be improved. Accordingly, the light absorbing switching element 12 includes the third substrate 1241, the third attachment layer 1231, the light absorbing panel 121, the fourth attachment layer 1232 and the fourth substrate 1242 that are stacked in sequence. Furthermore, a second decorative layer 125 may be optionally provided on the surface of the light absorbing switching element 12 away from the frame member 13. For example, the second decorative layer 125 may be provided on the side of the first substrate 1241 opposite to the light absorbing panel 121, so as to cover the conductive wire 122 to achieve aesthetic effect, but it is not limited thereto. The second decorative layer 125 includes, for example, light-shielding materials, such as ink, black photoresist, absorbing glue, other suitable materials, or a combination thereof.

FIG. 3A schematically illustrates the structure and operation of the light absorbing panel 121. The light absorbing panel 121 includes the substrate 1211a, the substrate 1211b, an electrode 1212a (for example, a transparent conductive electrode) and an electrode 1212b (for example, a transparent conductive electrode) respectively disposed on the substrate 1211a and the substrate 1211b, and liquid crystal molecules 1213 and dye molecules 1214 arranged between the electrode 1211a and the electrode 1212b. The light absorbing panel 121 in this embodiment is exemplified by a negative liquid crystal type, but it is not limited thereto. In other embodiments (not shown), the electrode design or the selected liquid crystal material of the light absorbing panel 121 may be adjusted according to the actual needs. As shown, when no voltage V is applied between the electrodes 1212a and 1212b (that is, there is no voltage difference), the axial direction of the liquid crystal molecules 1213 and the dye molecules 1214 is, for example, substantially perpendicular to the surface direction (X direction) of the substrate 1211a or 1211b and, at this moment, the extent of the light absorbed by the dye molecules 1214 is relatively small, thereby making the light absorbing panel 121 in a transparent state. When a voltage V is applied between the electrodes 12122a and 1212b (that is, there is a voltage difference) to generate an electric field E, the liquid crystal molecules 1213 and the dye molecules 1214 are axially rotated due to the influence of the electric field E, and the amplitude of the rotation may be adjusted according to the magnitude of the electric field E. When a larger electric field E is provided, the axial direction of the liquid crystal molecules 1213 and the dye molecules 1214 is generally parallel to the surface direction (Y direction) of the substrate 1211a or 1211b and, at this moment, the extent of the light absorbed by the dye molecules 1214 is relatively large, resulting in that the light absorbing panel 121 exhibits a dark state. By changing the magnitude of the applied voltage V to generate electric fields E of different magnitudes, it is able to adjust the degree of the dark state, thereby providing different gray-scale states to satisfy various dimming requirements.

FIG. 3B schematically illustrates the structure and operation of the light scattering panel 111. The light scattering panel 111 includes the substrate 1111a, the substrate 1111b, an electrode 1112a and an electrode 1112b respectively disposed on the substrate 1111a and the substrate 1111b, and a light scattering material 1113 arranged between the electrode 1112a and the electrode 1112b. In other embodiments (not shown), the electrode design or the selected liquid crystal material of the light absorbing panel 121 may be adjusted according to the actual needs. As shown, when no voltage V is applied between the electrodes 1112a and 1112b (that is, there is no voltage difference), the axial direction of the light scattering material 1113 is, for example, randomly arranged, and most of the ambient light incident on the light scattering panel 111 is scattered, for example, so that the light scattering panel 111 appears in a hazing state. When a voltage V is applied between the electrodes 1112a and 1112b (that is, there is a voltage difference) to generate an electric field E, due to the influence of the electric field E, the light scattering material 1113 is caused to rotate, and the amplitude of the rotation may be adjusted according to the magnitude of the electric field E. When the influence of the electric field E causes the axial direction of the light scattering material 1113 to be substantially perpendicular to the surface direction of the substrate 1211a or 1211b, most of the ambient light incident on the light scattering panel 111 may penetrate the light scattering panel 111, thereby making the light scattering panel 111 in a transparent state. By changing the magnitude of the applied voltage V to generate electric fields E of different magnitudes, it is able to adjust the degree of dark state, thereby providing different hazing or transparent states to satisfy various dimming requirements.

Please refer to FIG. 1B again. With the light scattering switching element 11 and the light absorbing switching element 12 assembled as mentioned above, the light scattering switching element 11 and the light absorbing switching element 12 may be attached to the opposite sides of the frame member 13 through the first attachment member 14 and the second attachment member 15, respectively, wherein the frame member 13 has, for example, an annular structure. In other words, the frame member 13 has, for example, a frame body with an opening 131 in the middle portion thereof. The light scattering switching element 11 is attached to one side of the frame member 13 through the first attachment member 14, for example. The light absorbing switching element 12 is, for example, attached to the other side of the frame member 13 through the second attachment member 15. The first attachment member 14 and/or the second attachment member 15 may include, for example, cured liquid glue or double-sided tape, but it is not limited thereto. By using the first attachment member 14 and/or the second attachment member 15 to attach the light scattering switching element 11 and the light absorbing switching element 12 to both sides of the frame member 13, it is able to form an accommodating space 101 among the light scattering switching element 11, the light absorbing switching element 12, the frame member 13, the first attachment member 14 and the second attachment member 15 for accommodating the thermal insulation layer 16. The thickness of the accommodating space 101 may, for example, vary with the size of the heat-insulating glass window. For example, the light scattering switching element 11 and the light absorbing switching element 12 are arranged along the X direction, and the thickness D of the accommodating space 101 in the X direction may be, for example, greater than 3 mm, greater than 4 mm, greater than 5 mm or greater than 6 mm, but it is not limited thereto. Since the thermal conductivity of the thermal insulation layer 16 in the accommodating space 101 is less than 50×10⁻³ W·m⁻¹·K⁻¹, the thermal insulation layer 16 may effectively block heat conduction and allow the light scattering switching element 11 to be less affected by heat. In one embodiment, the accommodating space 101 contains, for example, an inert gas as the thermal insulation layer 16. The inert gas is, for example, argon gas with a thermal conductivity of 17.72×10⁻³ W·m⁻¹·K⁻¹ or other suitable inert gases.

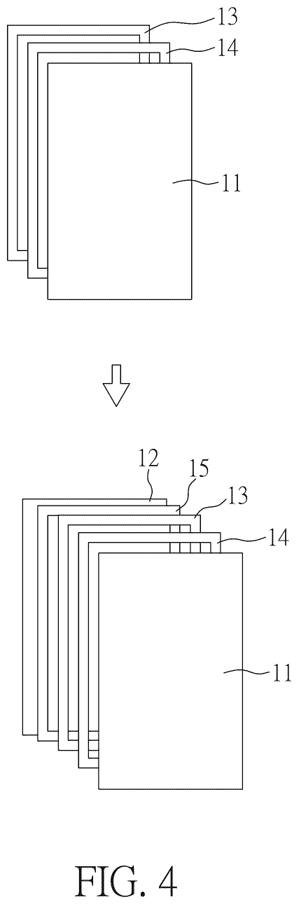

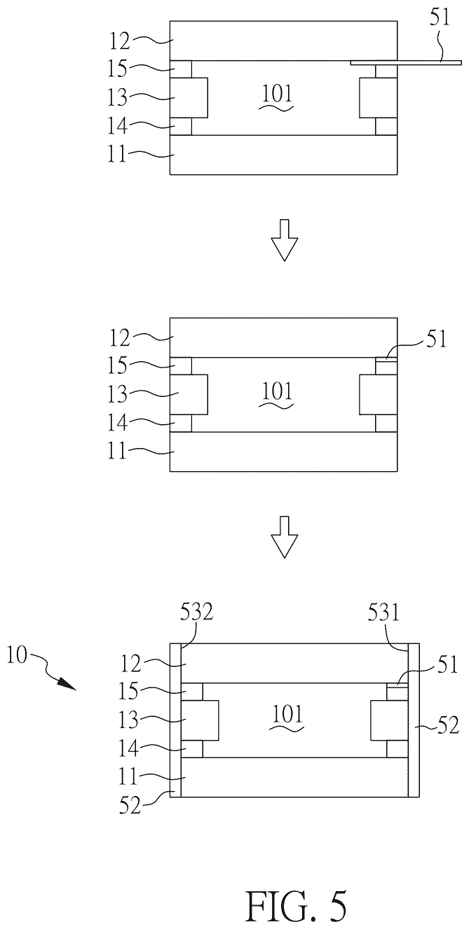

FIG. 4 schematically illustrates the process of assembling the light scattering switching element 11 and the light absorbing switching element 12 into an electronic device (for example, a heat-insulating window, but not limited to this). As shown, for example, the light scattering switching element 11 is first attached or fixed to one side of the frame member 13 through the first attachment member 14, and then the light absorbing switching element 12 is attached or fixed to the other side of the frame member 13 through the second attachment member 15, thereby completing the assembly of the electronic device. In addition, when assembling the aforementioned electronic device, the light absorbing switching element 12 may also be attached or fixed first, and then the light scattering switching element 11 may be attached or fixed, or the light scattering switching element 11 and the light absorbing switching element 12 may be attached or fixed at the same time. The present disclosure does not limit the order of the foregoing assembly. FIG. 5 schematically illustrates the process of introducing a thermal insulation layer (for example, an inert gas) among the light scattering switching element 11, the light absorbing switching element 12 and the frame member 13. As shown, first, when attaching or fixing the light scattering switching element 11 and the light absorbing switching element 12 to the frame 13, at least one transmission tube 51 may be inserted between the light scattering switching element 11 and the frame member 13 or between the light absorbing switching element 12 and the frame member 13. For convenience of explanation, FIG. 5 shows that the transmission tube 51 is inserted between the light absorbing switching element 12 and the frame member 13, and a thermal insulation layer (for example, inert gas) is introduced into the accommodating space 101 through the at least one transmission tube 51. Then, the transmission tube 51 is cut to be roughly aligned with the edge of the frame member 13, and a sieve (not shown) is inserted into the transmission tube 51 to prevent the thermal insulation layer (for example, inert gas) from leaking. Furthermore, protective glue 52 is provided on the first side 531 of the electronic device 10 that is inserted with the transmission tube 51 to protect the sieve inserted into the transmission tube 51 from falling off. Moreover, it is also applicable to coat the protective glue 52 on a second side 532 of the electronic device 10 that is opposite to the first side 531, so that the appearance of the heat-insulating glass window is symmetrical. It is noted that the above method is only an example, and the thermal insulation layer (for example, inert gas) may also be introduced through other methods. In another embodiment, the light scattering switching element 11, the light absorbing switching element 12 and the frame member 13 may be directly assembled in an environment or a machine filled with inert gas so as to realize the purpose of placing inert gas among the light scattering switching element 11, the light absorbing switching element 12 and the frame member 13 of the electronic device 10. With the aforementioned electronic device 10 used as a heat-insulating window, by controlling the transmitting state, the light-shielding state and the gray-scale state of the light absorbing switching element 12 and controlling the transmitting state and the hazing state of the light scattering switching element 11, it is able to provide various use modes including transmitting, light-shielding, projection, etc., as shown in Table 1 below:

TABLE 1

| | transmitting | light-shielding | projection |
|---|---|---|---|
| | mode | mode | mode |
| projector 19 | OFF | OFF | ON |
| light absorbing | transmitting | light-shielding | suitable |
| switching | state | state | gray-scale |
| element 12 | | | state |
| light scattering | transmitting | hazing state | hazing state |
| switching | state | | |
| element 11 | | | |

Therefore, in the transmitting mode, the electronic device 10 may be used as a light-transmitting window; in the light-shielding mode, the electronic device 10 may provide a sunshade effect; in the projection mode, the electronic device 10 may be used as a projection screen. Accordingly, it is able to satisfy the different needs of users in various usage scenarios.

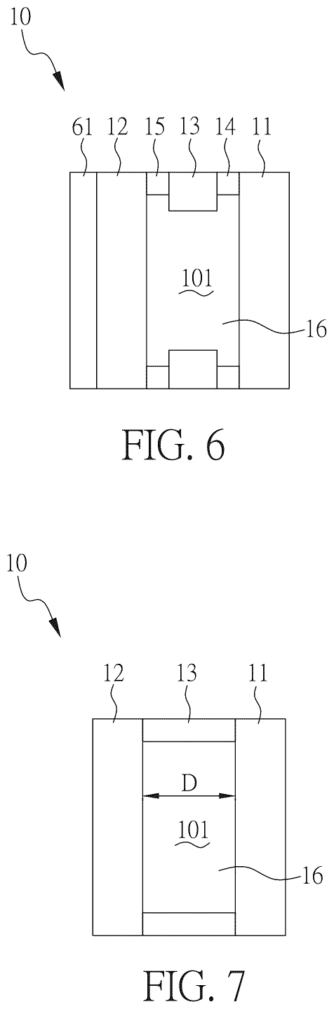

FIG. 6 is a schematic diagram of an electronic device 10 according to another embodiment of the present disclosure. This embodiment is similar to the embodiment of FIG. 1B, except that it further includes an anti-glare layer 61 disposed on the surface of the light absorbing switching element 12 away from the frame member 13, and the anti-glare layer 61 may include, for example, a polarizer, thereby reducing the generation of glare and effectively improving the quality of the heat-insulating glass window. In other embodiments, another light absorbing switching element may be attached on the surface of the light absorbing switching element 12, as shown in the embodiment of FIG. 1B, that is away from the frame member 13 through transparent glue, thereby enhancing the light-shielding effect of the heat-insulating window. FIG. 7 is a schematic diagram of an electronic device 10 according to still another embodiment of the present disclosure, wherein the electronic device 10 includes a light scattering switching element 11, a light absorbing switching element 12, a frame member 13 and a thermal insulation layer 16. This embodiment is similar to the embodiment of FIG. 1B, except that it does not have attachment members. Instead, the frame member 13 (for example, a ring-shaped frame member) provides the function of the attachment member. That is, the frame member 13 has adhesive properties, and the light scattering switching element 11 is attached to one side of the frame member 13 and the light absorbing switching element 12 is attached to the other side of the frame member 13 by using the frame member 13. Therefore, an accommodating space 101 is formed among the light scattering switching element 11, the light absorbing switching element 12 and the frame member 13, in which the thermal insulation layer 16 is disposed.

As can be seen from the above description, the electronic device of the present disclosure has a stacked structure in which the light scattering switching element and the light absorbing switching element are integrated into the frame member. Therefore, it can be applied to outdoor smart windows to provide good heat-insulating effect, and have both display and projection functions.

Features of various embodiments of the present disclosure may be mixed and matched as long as they do not violate the spirit of the disclosure or conflict with each other.

The aforementioned specific embodiments should be construed as merely illustrative, and not limiting the rest of the present disclosure in any way.

1. An electronic device, comprising:
a light scattering switching element;
a light absorbing switching element disposed opposite to the light scattering switching element; and
a thermal insulation layer disposed between the light scattering switching element and the light absorbing switching element,
wherein the thermal insulation layer has a thermal conductivity which is less than 50×10⁻³ W·m⁻¹·K⁻¹.

2. The electronic device as claimed in claim 1, further comprising a frame member, wherein the light scattering switching element is attached to one side of the frame member through a first attachment member, the light absorbing switching element is attached to the other side of the frame member through a second attachment member, there is an accommodating space formed among the light scattering switching element, the light absorbing switching element, the frame member, the first attachment member and the second attachment member, and the thermal insulation layer is disposed in the accommodating space.

3. The electronic device as claimed in claim 2, wherein the light scattering switching element and the light absorbing switching element are arranged along one direction, and a thickness of the accommodating space in the direction is greater than 3 mm.

4. The electronic device as claimed in claim 1, wherein the thermal insulation layer includes an inert gas.

5. The electronic device as claimed in claim 1, wherein the light scattering switching element includes a first substrate, a first attachment layer, a light scattering panel, a second attachment layer and a second substrate stacked in sequence.

6. The electronic device as claimed in claim 1, wherein the light absorbing switching element includes a third substrate, a third attachment layer, a light absorbing panel, a fourth attachment layer and a fourth substrate stacked in sequence.

7. The electronic device as claimed in claim 1, wherein a first decorative layer is disposed on a surface of the light scattering switching element away from the frame member, and a second decorative layer is disposed on a surface of the light absorbing switching element away from the frame member.

8. The electronic device as claimed in claim 1, further comprising an anti-glare layer disposed on a surface of the light absorbing switching element away from the frame member.

9. The electronic device as claimed in claim 1, further comprising another light absorbing switching element disposed on a surface of the light absorbing switching element away from the frame member.

10. The electronic device as claimed in claim 1, further comprising a frame member having adhesive properties, wherein the light scattering switching element is attached to one side of the frame member, the light absorbing switching element is attached to the other side of the frame member, an accommodating space is formed among the light scattering switching element, the light absorbing switching element and the frame member, and the thermal insulation layer is disposed in the accommodating space.

11. The electronic device as claimed in claim 5, wherein the light scattering panel includes two substrates; two electrodes respectively disposed on the two substrates; and a light scattering material disposed between the two electrodes.

12. The electronic device as claimed in claim 11, wherein a thickness of the substrate of the light scattering panel is between 1 mm and 0.2 mm.

13. The electronic device as claimed in claim 11, wherein each substrate of the light scattering panel has a peripheral circuit area disposed thereon a conductive wire.

14. The electronic device as claimed in claim 5, wherein a thickness of each of the first substrate and the second substrate is between 2 mm and 10 mm.

15. The electronic device as claimed in claim 6, wherein the light absorbing panel includes two substrates; two electrodes respectively disposed on the two substrates; and liquid crystal molecules and dye molecules disposed between the two electrodes.

16. The electronic device according to claim 16, wherein a thickness of the substrate of the light absorbing panel is between 1 mm and 0.2 mm.

17. The electronic device as claimed in claim 16, wherein each substrate of the light absorbing panel has a peripheral circuit area disposed thereon a conductive wire.

18. The electronic device as claimed in claim 6, wherein a thickness of each of the third substrate and the fourth substrate is between 2 mm and 10 mm.

19. The electronic device as claimed in claim 8, wherein the anti-glare layer includes a polarizer.

20. The electronic device as claimed in claim 2, wherein the frame member is a frame body with an opening in a middle portion of the frame body.
